(19) United States
(12) Patent Application Publication
(10) Pub. No.: US 2023/0369652 A1
(43) Pub. Date: Nov. 16, 2023

(54) SECONDARY BATTERY AND METHOD OF MANUFACTURING SECONDARY BATTERY

(71) Applicant: Murata Manufacturing Co., Ltd., Nagaokakyo-shi (JP)

(72) Inventor: Ryosuke YAMAMOTO, Nagaokakyo-shi (JP)

(21) Appl. No.: 18/359,398

(22) Filed: Jul. 26, 2023

Related U.S. Application Data
(63) Continuation of application No. PCT/JP2021/048659, filed on Dec. 27, 2021.

(30) Foreign Application Priority Data
Feb. 2, 2021 (JP) 2021-015104

(51) Int. Cl. H01M 10/058; H01M 50/547; H01M 50/531; H01M 50/103; H01M 50/147

(52) U.S. Cl. CPC H01M 10/058; H01M 50/547; H01M 50/531; H01M 50/103; H01M 50/147

(57) ABSTRACT

A secondary battery that includes an electrode assembly having a positive electrode, a negative electrode, and a separator between the positive electrode and the negative electrode; an exterior body that houses the electrode assembly; a terminal electrically connected to the positive electrode or the negative electrode; and an electrode lead electrically connected to the terminal and the positive electrode or the negative electrode, the electrode lead being bendable in all directions.

### CROSS REFERENCE TO RELATED APPLICATIONS

The present application is a continuation of International application No. PCT/JP2021/048659, filed Dec. 27, 2021, which claims priority to Japanese Patent Application No. 2021-015104, filed Feb. 2, 2021, the entire contents of each of which are incorporated herein by reference.

### TECHNICAL FIELD

The present invention relates to a secondary battery and a method of manufacturing the secondary battery. Particularly, the present invention relates to a secondary battery including an electrode assembly formed of an electrode-constituting layer including a positive electrode, a negative electrode, and a separator, and a method of manufacturing the same.

### BACKGROUND ART

Secondary batteries are so-called storage batteries and therefore can be repeatedly charged and discharged, and the secondary batteries are used in various applications. For example, the secondary batteries are used in mobile equipment such as mobile phones, smartphones, and laptop computers.

Patent Documents 1 to 4 disclose a secondary battery in which a battery element including a positive electrode, a negative electrode, and a separator is housed inside an exterior body including an external terminal, and a tab conducting the positive electrode or the negative electrode to the external terminal is provided. Furthermore, in the above-described Patent Documents, there is also known a device in which a belt-shaped tab is conducted to the external terminal, and then the belt-shaped tab is folded and housed in an exterior body (for example, Patent Document 1).
Patent Document 1: Japanese Patent Application Laid-Open No. 2009-170365
Patent Document 2: Japanese Patent Application Laid-Open No. 2004-355920
Patent Document 3: Japanese Patent No. 4293501
Patent Document 4: Japanese Patent Application Laid-Open No. 2008-066170

### SUMMARY OF THE INVENTION

The inventor of the present application has noticed that there is a problem to be overcome in the conventional secondary battery, and has found a need to take measures therefor. Specifically, the inventor of the present application has found that there is the following problem.

In a secondary battery in which a battery element is housed in an exterior body, it is desired to have a structure in which breakage of a bonding portion of a tab due to external impact and/or expansion and contraction of the battery element during charging and discharging hardly occurs. In the above-described secondary battery, the belt-shaped tab is easily bent in a thickness direction but is hardly bent in a width direction according to a sectional shape thereof. Therefore, when an external impact or the like is applied and the battery element moves in the width direction of the belt-shaped tab inside the battery, stress concentrates on the bonding portion of the belt-shaped tab, and the bonding portion may be damaged.

For example, in the invention disclosed in Patent Document 1, in a case where a difference between an inner diameter of a cylindrical exterior body and an outer diameter of a battery element which is a wound body is large, when an external impact is applied from a lateral direction, the wound body moves in a width direction of a belt-shaped tab, and there is a possibility that a welded portion of the belt-shaped tab is damaged.

The present invention has been made in view of such problems. That is, a main object of the present invention is to provide a technique relating to a secondary battery in which stress is less likely to concentrate on a bonding portion with an external terminal although when an external impact or the like is applied, and which is less likely to be damaged, and a method of manufacturing the secondary battery.

The inventor of the present application has attempted to solve the above-described problems by addressing the problems in a new direction rather than addressing the problems as an extension of the prior art. As a result, the present inventor has reached the invention of a secondary battery in which the above main object has been achieved.

According to an aspect of the present invention, there is provided a secondary battery that includes an electrode assembly having a positive electrode, a negative electrode, and a separator between the positive electrode and the negative electrode; an exterior body that houses the electrode assembly; a terminal electrically connected to the positive electrode or the negative electrode; and an electrode lead electrically connected to the terminal and the positive electrode or the negative electrode, the electrode lead being bendable in all directions.

According to another aspect of the present invention, there is provided a method of manufacturing a secondary battery, the method including: bonding an electrode lead bendable in all directions to a positive electrode or a negative electrode of an electrode assembly that includes the positive electrode, the negative electrode and a separator between the positive electrode and the negative electrode; and bending the electrode lead toward the terminal.

According to the present invention, since the electrode lead electrically connecting the terminal and the positive electrode or the negative electrode is bendable in all directions, restriction in the bending direction can be reduced as compared with a belt-shaped lead. Therefore, bending can be easily performed in a free direction, and although when an external impact or the like is applied, stress is less likely to concentrate on a bonding portion with the external terminal, and breakage can be less likely to occur.

### BRIEF EXPLANATION OF THE DRAWINGS

FIGS. 1(a) and 1(b) schematically show an electrode assembly, where FIG. 1(a) is a sectional view illustrating a planar stacked structure, and FIG. 1(b) is a sectional view illustrating a wound structure.

FIG. 2 is a plan view and a side view of a positive electrode and a separator according to a secondary battery of a first embodiment.

FIG. 3 is a plan view and a side view of a negative electrode according to the secondary battery of the first embodiment.

FIGS. 4(a) and 4(b) are views illustrating a form in the middle of manufacturing the secondary battery of the first embodiment, where FIG. 4(a) is a sectional view illustrating a state before a positive electrode or a negative electrode is collected, and FIG. 4(b) is a plan view of FIG. 4 (a).

FIGS. 5(a) and 5(b) are views illustrating a form in the middle of manufacturing the secondary battery of the first embodiment, where FIG. 5(a) is a sectional view illustrating a state after a positive electrode or a negative electrode is collected, and FIG. 5(b) is a plan view of FIG. 5(a).

FIGS. 6(a) and 6(b) are views illustrating a form in the middle of manufacturing the secondary battery of the first embodiment, where FIG. 6(a) is a sectional view illustrating an electrode lead is attached, and FIG. 6(b) is a plan view of FIG. 6(a).

FIGS. 7(a) and 7(b) are views illustrating a form in the middle of manufacturing the secondary battery of the first embodiment, where FIG. 7(a) is a sectional view illustrating a state in which the electrode assembly is covered with an insulating member, and FIG. 7(b) is a plan view of FIG. 7(a).

FIG. 8 is a view illustrating a form in the middle of manufacturing the secondary battery of the first embodiment, and is a plan view illustrating a state in which the electrode lead is covered with an insulating member.

FIG. 9 is a view illustrating a form in the middle of manufacturing the secondary battery of the first embodiment, and is a plan view illustrating a state in which the electrode lead is bent.

FIGS. 10(a) and 10(b) are views illustrating a form in the middle of manufacturing the secondary battery of the first embodiment, where FIG. 10(a) is a plan view illustrating a state in which an electrode assembly is housed in an exterior body, and FIG. 10(b) is a sectional view on one electrode side in FIG. 10(a).

FIGS. 11(a) and 11(b) are views illustrating a form in the middle of manufacturing the secondary battery of the first embodiment, where FIG. 11(a) is a sectional view on one electrode side, and FIG. 11(b) is a sectional view on the other electrode side.

FIG. 12 is a sectional view illustrating a form in the middle of manufacturing the secondary battery of the first embodiment.

FIGS. 13(a) and 13(b) schematically illustrate an exemplary embodiment of a secondary battery of the present invention, where FIG. 13(a) is a perspective view of a rectangular secondary battery, and FIG. 13(b) is a perspective view of a button type or coin type secondary battery.

FIGS. 14(a) and 14(b) are views illustrating a form in the middle of manufacturing a secondary battery of a second embodiment, where FIG. 14(a) is a sectional view illustrating a state before a positive electrode or a negative electrode is collected, and FIG. 14(b) is a sectional view illustrating a state where an electrode lead is attached by collecting the positive electrode or the negative electrode.

FIGS. 15(a) and 15(b) are views illustrating a form in the middle of manufacturing the secondary battery of the second embodiment, where FIG. 15(a) is a sectional view illustrating a state in which the collected positive electrode and a collected negative electrode are bent, and FIG. 15(b) is a sectional view illustrating a state in which the electrode leads are wound by collecting the positive electrode and the negative electrode.

FIGS. 16(a) and 16(b) are views illustrating a form in the middle of manufacturing a secondary battery of a third embodiment, where FIG. 16(a) is a plan view illustrating a state where an electrode assembly is housed in an exterior body, and FIG. 16(b) is a sectional view on a negative electrode side of FIG. 16(a).

FIGS. 17(a) and 17(b) are views illustrating a form in the middle of manufacturing the secondary battery of the third embodiment, where FIG. 17(a) is a sectional view illustrating a state in which the electrode lead on the negative electrode side is attached to a lid-shaped member, and FIG. 17(b) is a sectional view illustrating a state in which the lid-shaped member and a cup-shaped member are welded.

### DETAILED DESCRIPTION OF THE INVENTION

Hereinafter, a secondary battery according to an embodiment of the present invention will be described in more detail. Although the description will be made with reference to the drawings as necessary, various elements in the drawings are merely schematically and exemplarily shown for understanding of the present invention, and the appearance, the dimensional ratio, or the like can be different from those of an actual secondary battery. In the following description, the description of the secondary battery and the description of the method of manufacturing the secondary battery are both made.

[Description of Secondary Battery of Present Invention]

The term “secondary battery” as used in the present specification refers to a battery that can be repeatedly charged and discharged. Accordingly, the secondary battery according to the present invention is not excessively limited by its name, and for example, a power storage device and the like may also be included in the subject of the present invention.

### First Embodiment of Secondary Battery

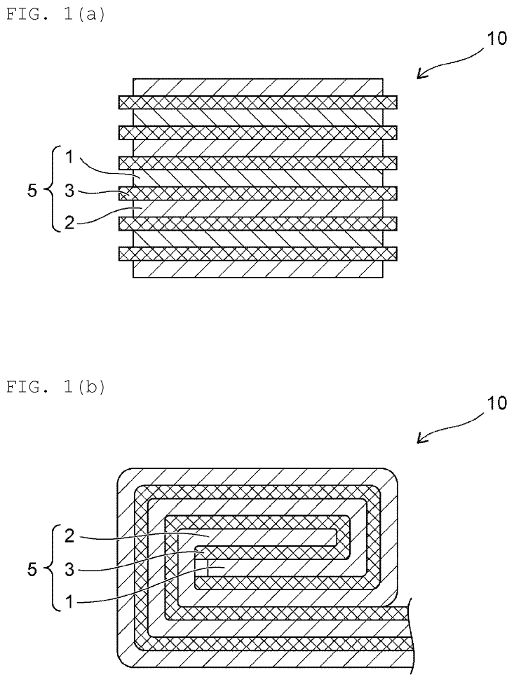

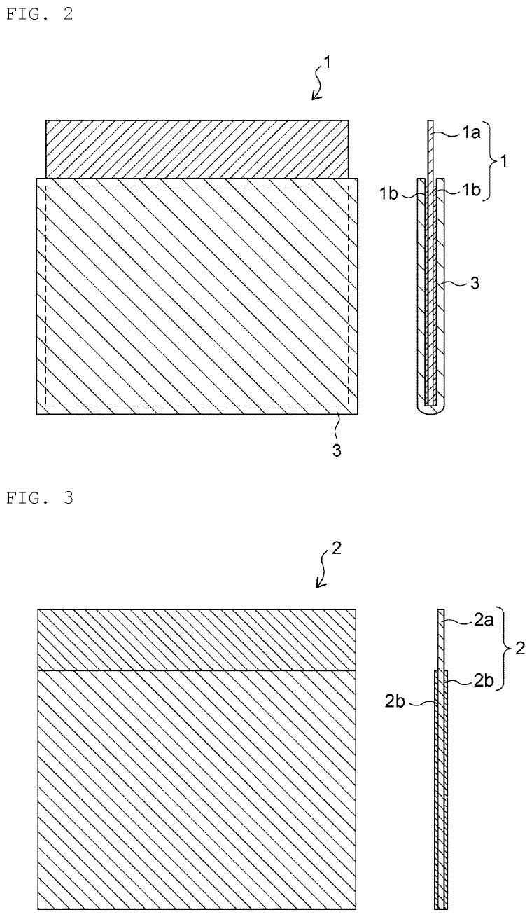

A secondary battery according to a first embodiment of the present invention will be described with reference to FIGS. 1(a) to 13(b). The secondary battery according to the present invention has an electrode assembly 10 including an electrode-constituting layer 5 including a positive electrode 1, a negative electrode 2, and a separator 3. FIGS. 1(a) and 1(b) illustrate the electrode assembly 10. As illustrated, the positive electrode 1 and the negative electrode 2 are stacked with the separator 3 interposed therebetween to form the electrode-constituting layer 5, and at least one or more of the electrode-constituting layers 5 are stacked to configure the electrode assembly 10. FIG. 1(a) may have a planar stacked structure in which the electrode-constituting layers 5 are stacked in a planar shape without being wound. More specifically, the electrode assembly 10 may have a configuration in which the electrode-constituting layers 5 are stacked so as to be stacked on each other. On the other hand, FIG. 1(b) may have a wound structure in which the electrode-constituting layer 5 extending relatively long in a belt shape is wound in a wound shape. More specifically, FIG. 1(b) may have a wound structure in which the electrode-constituting layers 5 extending relatively long in a belt shape including the positive electrode 1, the negative electrode 2, and the separator 3 disposed between the positive electrode 1 and the negative electrode 2 are wound in a roll shape. In the secondary battery, such an electrode assembly 10 may be enclosed in an exterior body 50 together with an electrolyte (for example, a non-aqueous electrolyte). It is to be noted that the structure of the electrode assembly 10 is not necessarily limited to the planar stacked structure or the wound structure, and for example, the electrode assembly 10 may have a so-called stack-and-folding type structure in which the positive electrode 1, the separator 3, and the negative electrode 2 are stacked on a long film and then folded.

The positive electrode 1 has at least a positive electrode current collector 1a and a positive electrode material layer 1b, and the separator 3 may be provided around the positive electrode 1 so as to bag the positive electrode 1 (refer to FIG. 2).

The positive electrode current collector 1a is a member that contributes to collection and supply of electrons generated in the electrode active material by the battery reaction. For example, the positive electrode current collector 1a may have a rectangular shape by cutting a sheet-shaped metal member, or may have a porous or perforated form. In addition, the electrode current collector may be a metal foil, a punching metal, a net, an expanded metal, or the like. When a simple rectangular metal member having a sheet shape is used, the sheet can be easily conveyed. Further, since the positive electrode current collector 1a can be formed by cutting the conveyed metal foil, a mold for punching the metal foil is not required. Therefore, it is possible to reduce the die cost and the recovery of remaining materials after the die punching.

The positive electrode current collector 1a used for, for example, the positive electrode may be made of a metal foil containing at least one selected from the group consisting of aluminum, stainless steel, nickel, and the like, and is preferably, for example, an aluminum foil.

The positive electrode material layer 1b may include a positive electrode active material as an electrode active material. For example, for the plurality of positive electrodes 1 in the electrode assembly 10, for each of the electrodes, the positive electrode material layer 1b may be provided on both sides of the positive electrode current collector 1a, or the positive electrode material layer 1b may be provided only on one side of the positive electrode current collector 1a. The positive electrode active material of the positive electrode material layer 1b is formed of, for example, a particulate material, and a binder may be included in the positive electrode material layer 1b for more sufficient contact between the particles and shape retention. Furthermore, a conductive auxiliary agent may be included in the positive electrode material layer 1b to facilitate the transfer of electrons promoting a battery reaction. As described above, because a plurality of components are contained, the positive electrode material layer 1b can also be referred to as a “positive electrode mixture layer”. In the form of FIG. 2 illustrating an example of the present embodiment, the positive electrode 1 is obtained by applying the positive electrode material layer 1b to the positive electrode current collector 1a, and the width of the positive electrode current collector 1a and the width of the positive electrode material layer 1b may be substantially equal. The “width of the positive electrode current collector” and the “width of the positive electrode material layer” used herein indicate the length of a boundary portion between the current collector and the electrode material layer, and in the present embodiment, mean the length of a boundary portion between the positive electrode current collector 1a and the positive electrode material layer 1b. More specifically, it means a length in a direction orthogonal to a direction in which the positive electrode current collector 1a extends so as to be exposed from the positive electrode material layer 1b. In addition, “substantially equal” as used in the present specification includes including tolerance of about ±10% in addition to being exactly equal. According to such a configuration, the width of the positive electrode current collector 1a can be made relatively wide, and breakage at the time of current collection of the positive electrode current collector described later can be reduced.

The positive electrode active material may be a material that contributes to occlusion and release of lithium ions. From such a viewpoint, the positive electrode active material is preferably, for example, a lithium-containing composite oxide. More specifically, the positive electrode active material is preferably a lithium transition metal composite oxide containing lithium and at least one transition metal selected from the group consisting of cobalt, nickel, manganese, and iron. More specifically, in the positive electrode material layer 1b of the secondary battery according to the present invention, such a lithium transition metal composite oxide is preferably included as a positive electrode active material. For example, the positive electrode active material may be a lithium cobaltate, a lithium nickelate, a lithium manganate, a lithium iron phosphate, or a material obtained by replacing a part of the transition metal thereof with another metal. Such a positive electrode active material may be contained singly or in combination of two or more.

The binder that can be included in the positive electrode material layer 1b is not particularly limited, and examples thereof include at least one selected from the group consisting of a polyvinylidene fluoride, a vinylidene fluoride-hexafluoropropylene copolymer, a vinylidene fluoride-tetrafluoroethylene copolymer, and a polytetrafluoroethylene. The conductive auxiliary agent that can be included in the positive electrode material layer 1b is not particularly limited, and examples thereof include at least one selected from carbon black such as thermal black, furnace black, channel black, ketjen black, and acetylene black, carbon fibers such as graphite, carbon nanotubes, and vapor-grown carbon fibers, metal powders such as copper, nickel, aluminum, and silver, and polyphenylene derivatives.

The thickness dimension of the positive electrode material layer 1b is not particularly limited, and may be 1 μm to 300 μm, and is, for example, 5 μm to 200 μm. The thickness dimension of the positive electrode material layer is a thickness inside the secondary battery, and the average value of measured values at random 10 points may be employed.

The separator 3 for packing the positive electrode 1 is a member provided from the viewpoint of preventing a short circuit due to contact between the positive and negative electrodes, electrolyte retention, and the like. In other words, it can be said that the separator 3 is a member that passes ions while preventing electronic contact between the positive electrode 1 and the negative electrode 2. Preferably, the separator 3 may be a porous or microporous insulating member, and although it is merely an example, a microporous membrane made of polyolefin may be used as the separator 3. In this respect, the microporous membrane for use as the separator 3 may include, for example, only a polyethylene (PE) or only a polypropylene (PP) as the polyolefin. Furthermore, in the present embodiment, the separator 3 is provided so as to pack the positive electrode 1, but instead of this aspect, it may be a laminate including a “microporous membrane made of PE” and a “microporous membrane made of PP”. The surface of the separator 3 may be covered with an inorganic particle covering layer and/or an adhesive layer. The surface of the separator 3 may have adhesiveness. Note that the separator 3 is not particularly limited by its name in the present invention, and may be a solid electrolyte, a gel electrolyte, insulating inorganic particles, or the like having a similar function.

The thickness dimension of the separator is not particularly limited, and may be 1 μm to 100 μm, and is, for example, 2 μm to 20 μm. The thickness dimension of the separator is a thickness inside the secondary battery (particularly, the thickness between the positive electrode and the negative electrode), and the average value of measured values at random 10 points may be employed.

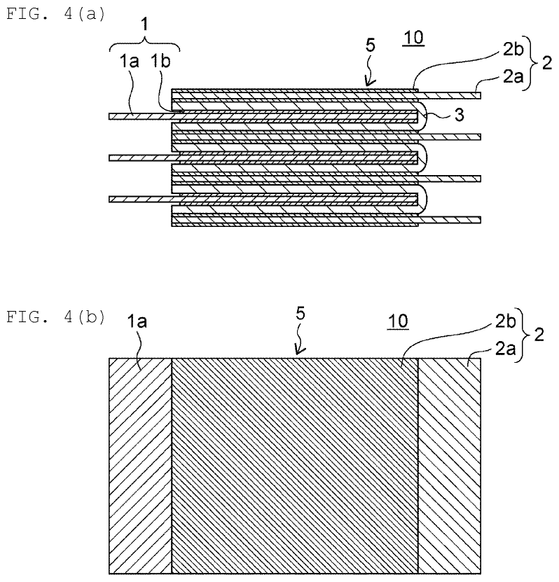

The negative electrode 2 may be formed of at least a negative electrode current collector 2a and a negative electrode material layer 2b (refer to FIG. 3). In addition, the area of the negative electrode 2 is preferably larger than the area of the positive electrode 1 in order not to cause electric field deposition.

The negative electrode current collector 2a is a member that contributes to collection and supply of electrons generated in the electrode active material by the battery reaction. Similarly to the positive electrode current collector 1a, for example, it may have a rectangular shape by cutting a sheet-shaped metal member, or may have a porous or perforated form. As an example, the negative electrode current collector 2a used for the negative electrode 2 is preferably made of a metal foil containing at least one selected from the group consisting of nickel, copper, nickel-plated copper, stainless steel (SUS), and the like, and may be, for example, a copper foil. It is to be noted that the term “stainless steel” in the present specification refers to, for example, the stainless steel defined in “JIS G 0203 Glossary of terms used in iron and steel”, which may be an alloy steel containing chromium or containing chromium and nickel.

The negative electrode material layer 2b may contain a negative electrode active material as an electrode active material. For example, for the plurality of negative electrodes 2 in the electrode assembly 10, for each of the electrodes, the negative electrode material layer 2b may be provided on both sides of the negative electrode current collector 2a, or the negative electrode material layer 2b may be provided only on one surface of the negative electrode current collector 2a. The negative electrode active material of the negative electrode material layer 2b is formed of, for example, a particulate material, and a binder may be included in the negative electrode material layer 2b for more sufficient contact between the particles and shape retention. Furthermore, a conductive auxiliary agent may be included in the negative electrode material layer 2b to facilitate the transfer of electrons promoting a battery reaction. As described above, because a plurality of components are contained, the negative electrode material layer 2b can also be referred to as a “negative electrode mixture layer”. In the form of FIG. 3 illustrating an example of the present embodiment, the negative electrode 2 is obtained by applying the negative electrode material layer 2b to the negative electrode current collector 2a, and the width of the negative electrode current collector 2a and the width of the negative electrode material layer 2b may be substantially equal. According to such a configuration, the width of the negative electrode current collector 2a can be made relatively wide, and breakage at the time of current collection can be reduced.

The negative electrode active material may be a material that contributes to occlusion and release of lithium ions. From this viewpoint, as the negative electrode active material, for example, various carbon materials, oxides, and/or lithium alloys are preferred.

Examples of the various carbon materials for the negative electrode active material include graphite (natural graphite and artificial graphite), hard carbon, soft carbon, and diamond-like carbon. Particularly, graphite has high electron conductivity and excellent adhesiveness to the negative electrode current collector. Examples of the oxides for the negative electrode active material include at least one selected from the group consisting of a silicon oxide, a tin oxide, an indium oxide, a zinc oxide, and a lithium oxide. The lithium alloys for the negative electrode active material may be any metal that can be alloyed with lithium, and may be, for example, a binary, ternary, or higher alloy of lithium and a metal such as Al, Si, Pb, Sn, In, Bi, Ag, Ba, Ca, Hg, Pd, Pt, Te, Zn, and La. Such an oxide is preferably amorphous as its structural form. This is because deterioration due to nonuniformity such as crystal grain boundaries or defects is less likely to be caused.

The binder that can be included in the negative electrode material layer 2b is not particularly limited, and examples thereof include at least one selected from the group consisting of styrene butadiene rubber, polyacrylic acid, polyvinylidene fluoride, polyimide resin, and polyamideimide resin. The conductive auxiliary agent that can be included in the negative electrode material layer 2b is not particularly limited, and examples thereof include at least one selected from carbon black such as thermal black, furnace black, channel black, ketjen black, and acetylene black, carbon fibers such as graphite, carbon nanotubes, and vapor-grown carbon fibers, metal powders such as copper, nickel, aluminum, and silver, and polyphenylene derivatives. Note that the negative electrode material layer 2b may contain a component resulting from a thickener component (for example, carboxymethylcellulose) used during battery manufacture.

The thickness dimension of the negative electrode material layer 2b is not particularly limited, and may be 1 μm to 300 μm, and is, for example, 5 μm to 200 μm. The thickness dimension of the negative electrode material layer is a thickness inside the secondary battery, and the average value of measured values at random 10 points may be employed.

In the secondary battery of the present embodiment, the positive electrode 1 packed by the separator 3 and the negative electrode 2 are stacked and pressed by pick and place, respectively, thereby forming the electrode assembly 10 having the electrode-constituting layer 5 (refer to FIGS. 4(a) and 4 (b)).

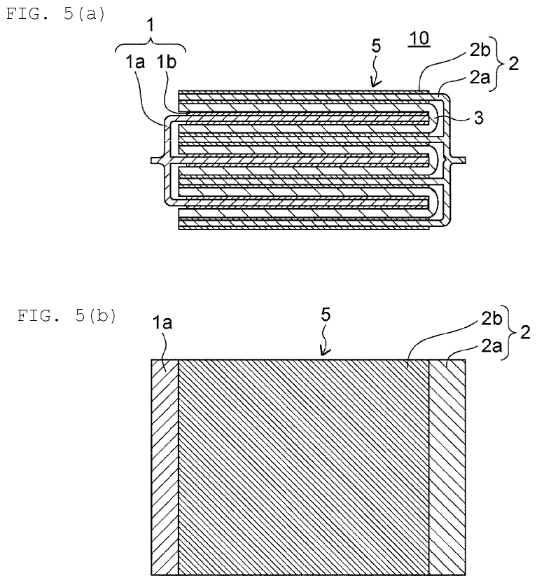

In the electrode assembly 10, the positive electrode current collector 1a of each layer may be collected to each other, and the negative electrode current collector 2a of each layer may be collected to each other (refer to FIGS. 5(a) and 5(b)). A method for collecting currents only needs to be capable of electrically collecting currents, and may be, for example, ultrasonic welding, resistance welding, pressure-bonding connection, or the like.

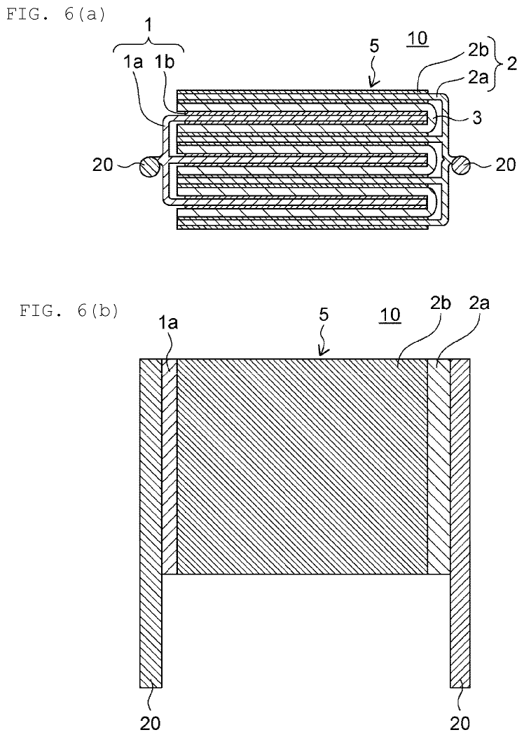

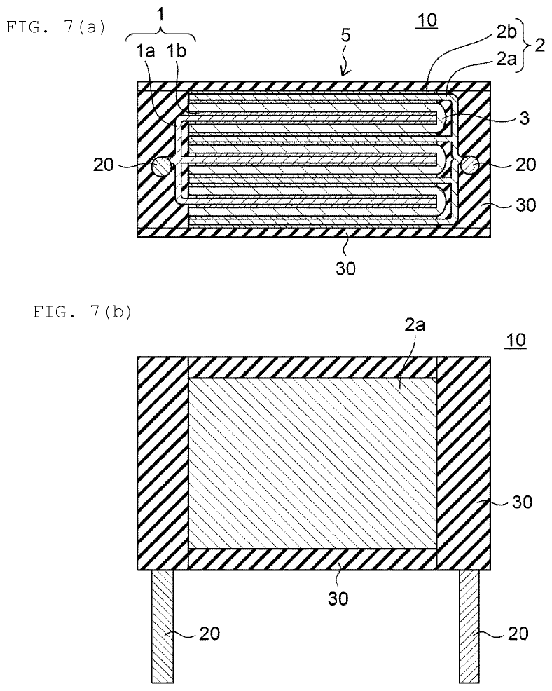

The collected positive electrode current collector 1a and negative electrode current collector 2a may be electrically connected to the electrode lead 20 (refer to FIGS. 6(a) and 6(b)). In the present embodiment, the material of the electrode lead 20 electrically connected to the positive electrode current collector 1a may be, for example, aluminum, and the material of the electrode lead 20 electrically connected to the negative electrode current collector 2a may include, for example, at least one selected from the group consisting of nickel, copper, nickel-plated copper, and stainless steel (SUS). By using such a material of the electrode lead 20, it is possible to prevent the battery reaction of the positive electrode or the negative electrode from being affected by the non-aqueous electrolyte housed in the exterior body 50. The positive electrode current collector 1a or the negative electrode current collector 2a and the electrode lead 20 connected thereto may be connected by welding, and for example, welding using a resistance spot, a laser, or an ultrasonic wave may be used.

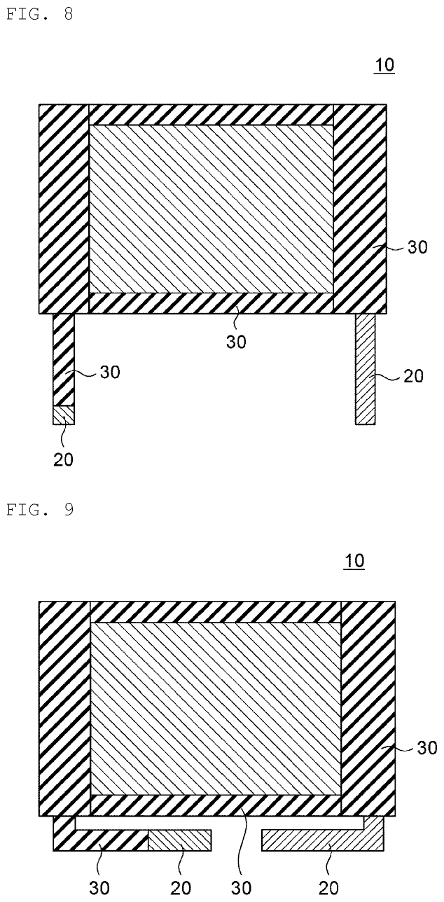

Outer peripheral edges of the electrode lead 20 and the electrode assembly 10 may be covered with an insulating member 30 in order to prevent a short circuit with the exterior body 50 when housed in the exterior body 50 made of metal described later (refer to FIGS. 7(a) and 7(b)). In the present embodiment, an insulating tape is attached to all the outer peripheral edges of the electrode assembly 10 and both the electrode leads 20, but in consideration of the influence of the insulating tape on the non-aqueous electrolyte, only the electrode lead 20 (that is, the electrode lead electrically connected to the positive electrode) on the side connected to a terminal 60 may be covered with the insulating tape.

Further, in the electrode lead 20 on the side connected to the terminal 60, in order to prevent a short circuit with respect to the portion where the electrode lead 20 is bent, an insulating tape may be attached, a shrinkable tube covering that can withstand a non-aqueous electrolyte, or a sealant treatment may be performed (refer to FIG. 8).

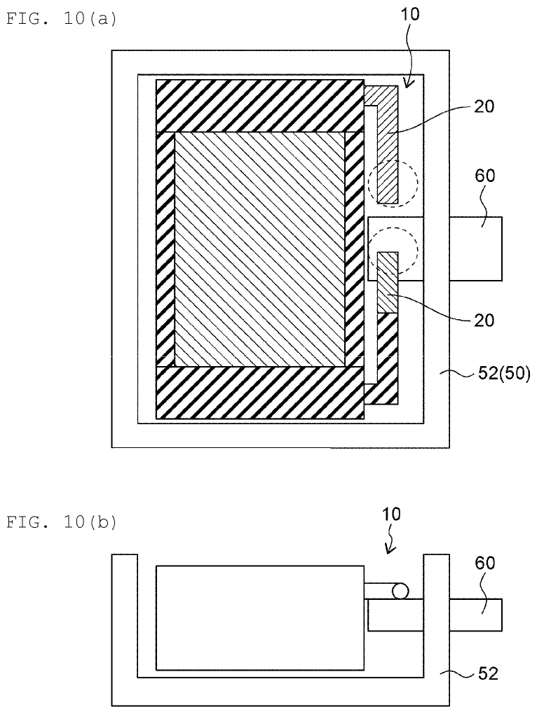

Here, the electrode lead 20 in the present invention is bendable in all directions (refer to FIG. 9). The term “bendable in all directions” as used in the present specification means an aspect (for example, a mode in which the value of the second moment of area of the electrode lead 20 is included within 25% in all directions) in which there is no significant difference in bending characteristics in all directions. As an example, the electrode lead 20 may be a wire rod having a circular sectional shape, and according to such a configuration, it is possible to bend by the same displacement amount with the same force in any direction as compared with the “belt-shaped tab” disclosed in the prior art. The sectional shape of the wire rod is not necessarily limited to a perfect circle, and may be an ellipse or the like as long as there is no significant difference in bending characteristics with respect to each bending direction. Such a wire rod is inexpensive as compared with the “belt-shaped tab”, and thus can achieve cost reduction. Furthermore, by using a wire rod having a circular or elliptical sectional shape, when the electrode lead 20 is electrically connected to the terminal 60, the electrode lead 20 comes into line contact with the terminal 60 when the electrode lead 20 is pressurized, so that bonding stability like projection welding can be expected. Note that the “wire rod” in the present specification means a linear member having a second moment of area to the extent that the member is bendable in all directions. Furthermore, the values of the second moment of area of the electrode lead 20 are preferably substantially equal in all directions. With such an electrode lead 20, as illustrated in FIG. 9, the electrode lead 20 can be bent along an outer peripheral edge of the electrode assembly 10, in other words, the end portions of the electrode lead 20 can be bent so as to face each other. The second moment of area of the electrode lead 20 will be described later.

The electrode assembly 10 in which the electrode lead 20 is bent may be enclosed in the exterior body 50 together with the electrolyte. The electrolyte can assist the movement of metal ions released from the electrodes (positive electrode 1 and/or negative electrode 2). The electrolyte may be a “non-aqueous” electrolyte, such as an organic electrolyte and an organic solvent, or may be an “aqueous” electrolyte containing water. When the positive electrode 1 and the negative electrode 2 have a layer capable of occluding and releasing lithium ions, the electrolyte is preferably a “non-aqueous” electrolyte including an organic electrolyte, an organic solvent, and the like. That is, the electrolyte preferably serves as a non-aqueous electrolyte. In the electrolyte, metal ions released from the electrodes (positive electrode and/or negative electrode) will be present, and the electrolyte will thus assist the movement of the metal ions in the battery reaction. It is to be noted that the electrolyte may have a form such as a liquid form or a gel form.

The non-aqueous electrolyte is an electrolyte including a solvent and a solute. A specific solvent for the non-aqueous electrolyte may contain at least a carbonate. Such carbonates may be cyclic carbonates and/or chain carbonates. Although not particularly limited, examples of the cyclic carbonates include at least one selected from the group consisting of a propylene carbonate (PC), an ethylene carbonate (EC), a butylene carbonate (BC), and a vinylene carbonate (VC). Examples of the chain carbonate include at least one selected from the group consisting of a dimethyl carbonate (DMC), a diethyl carbonate (DEC), an ethyl methyl carbonate (EMC), and a dipropyl carbonate (DPC). By way of an example only, combinations of cyclic carbonates and chain carbonates may be used as the non-aqueous electrolyte, and for example, a mixture of an ethylene carbonate and a diethyl carbonate may be used. As a specific solute for the non-aqueous electrolyte, for example, Li salts such as LiPF₆ and/or LiBF₄ may be used.

The exterior body 50 may be a member capable of housing or enclosing the electrode assembly 10. The exterior body 50 is preferably a metal exterior body that has a non-laminate configuration. The metal exterior body may be a single member made of a metal such as stainless steel (SUS) and/or aluminum. The term “single metal member” as used herein means that the exterior body 50 has no so-called laminate configuration in a broad sense, and means that the exterior body 50 is a member substantially made of only a metal in a narrow sense. Thus, as long as the metal exterior body is a member made substantially of only a metal, the surface of the metal exterior body may be subjected to an appropriate surface treatment.

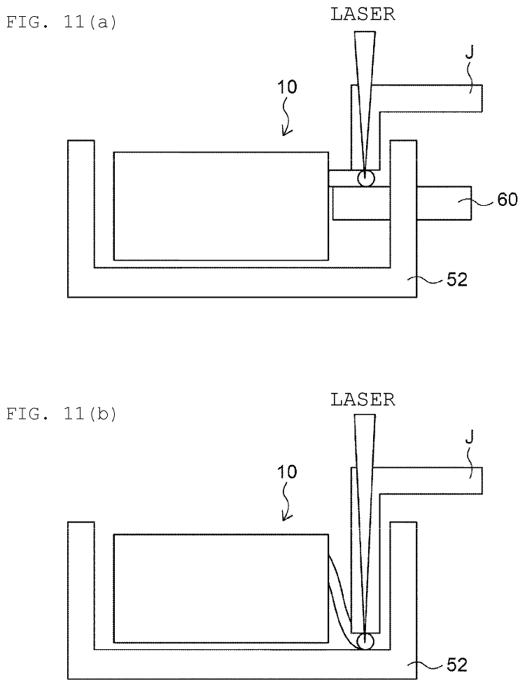

From the viewpoint of easily housing the electrode assembly 10, the exterior body 50 may include a lid-shaped member 51 and a cup-shaped member 52, and the lid-shaped member 51 and the cup-shaped member 52 may be bonded to each other by welding. The cup-shaped member 52 of the present embodiment may be provided with a terminal 60 (refer to FIGS. 10(a) to 12). It is to be noted that the “cup-shaped member” in the present specification means such a member that has a side surface corresponding to the body and a main surface (according to a typical aspect, for example, a bottom) that is continuous with the side surface, and forms a hollow therein. The “lid-shaped member” in the present specification means a member provided so as to cover such a cup-shaped member. The lid-shaped member may be, for example, a single member (typically a flat plate-shaped member) extending in the same plane. For the exterior body 50, the lid-shaped member and the cup-shaped member may be combined such that an outer edge part of the lid-shaped member 51 and an upper end part of the outer peripheral edge portion of the cup-shaped member 52 fit with each other.

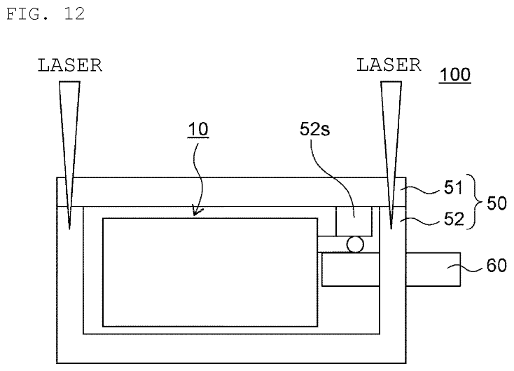

One electrode lead 20 may be electrically connected to the terminal 60 (FIG. 11(a)), and the other electrode lead 20 may be electrically connected to the cup-shaped member 52 (FIG. 11(b)). The electrical connection may be performed by laser welding, resistance welding, ultrasonic welding, or the like. Specifically, laser welding may be performed in a state where the electrode lead 20 is pressed by a jig J. The jig J is a jig used for pressing the electrode lead 20, and may be made of a material that does not interfere with laser welding. The welding can be easily performed by using the jig J. In the present embodiment, an aspect in which the electrode lead 20 electrically connected to the positive electrode 1 is electrically connected to the terminal 60, and the electrode lead 20 electrically connected to the negative electrode 2 is electrically connected to the exterior body (cup-shaped member 52) has been described, but the present invention is not limited to this example, and the electrical connection aspect may be reversed. That is, the electrode lead 20 electrically connected to the negative electrode 2 may be electrically connected to the terminal 60, and the electrode lead 20 electrically connected to the positive electrode 1 may be electrically connected to the exterior body (cup-shaped member 52).

The lid-shaped member 51 may be provided with an insulating member 52s in order to achieve insulation from the terminal 60 and the electrode lead 20 connected to the terminal 60. As an example of the insulating member 52s, for example, an insulating tape may be used. The electrode assembly 10 may be housed in the exterior body 50 by laser welding the lid-shaped member 51 and the cup-shaped member 52. The welding between the lid-shaped member 51 and the cup-shaped member 52 is not limited to the laser welding, and other bonding methods may be adopted.

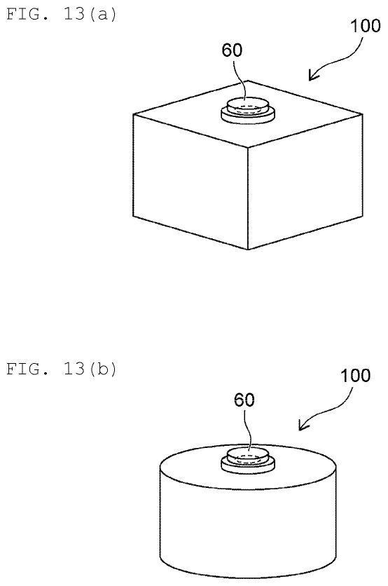

In this aspect, a secondary battery 100 has a substantially rectangular shape as viewed from the terminal 60 side. That is, the secondary battery 100 is rectangular in terms of an outer shape (refer to FIG. 13(a)). The present invention is, however, not necessarily limited thereto. For example, a button or coin type secondary battery may be used (refer to FIG. 13(b)). That is, the secondary battery 100 is not limited to a rectangular shape when viewed from the terminal side, and may have a shape such as a circular shape or an elliptical shape.

As described above, according to the present embodiment, since the electrode lead 20 electrically connecting the terminal 60 and the positive electrode 1 or the negative electrode 2 is bendable in all directions, restriction in the bending direction can be reduced as compared with a belt-shaped lead. Therefore, bending can be easily performed in a free direction, and although when an external impact or the like is applied, stress is less likely to concentrate on a bonding portion with the external terminal.

The above-described method of manufacturing a secondary battery includes a bonding step of bonding the electrode lead 20 as a wire rod to the positive electrode 1 or the negative electrode 2, and a bending step of bending the electrode lead 20 toward the terminal 60.

In addition, in the bending step in the above-described method of manufacturing a secondary battery, the electrode lead may be bent along the outer peripheral edge of the electrode assembly 10. By bending the electrode lead along the outer peripheral edge of the electrode assembly 10 in this manner, a volume ratio of the electrode assembly 10 to the exterior body 50 can be relatively increased, and the energy density per unit volume or the battery capacity of the secondary battery can be improved.

### Second Embodiment of Secondary Battery

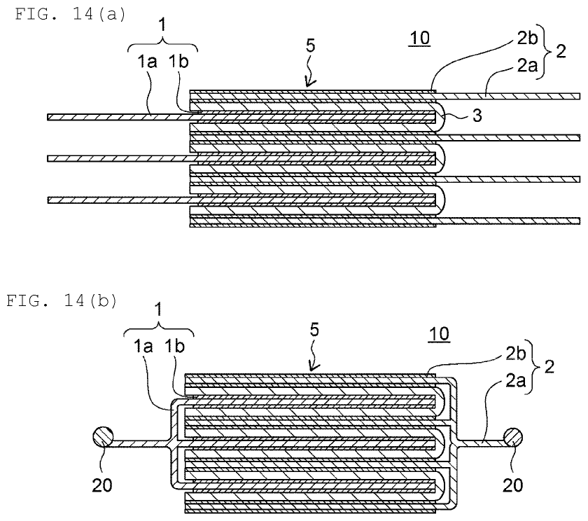

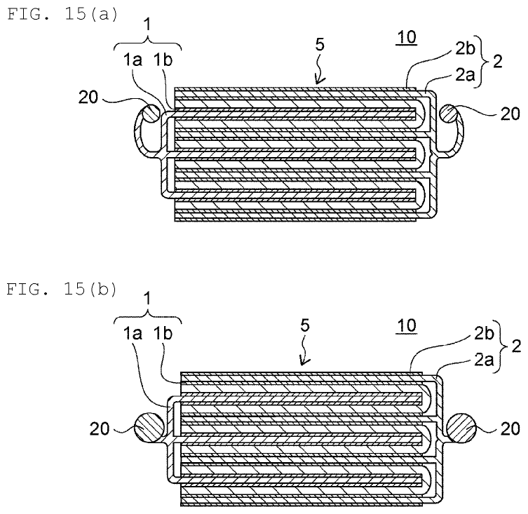

A secondary battery according to a second embodiment of the present invention will be described with reference to FIGS. 14(a) through 15(b). It is to be noted that description of the same configuration as that of the first embodiment will be omitted.

In the secondary battery according to the present embodiment, from the viewpoint of easily collecting the positive electrode current collector 1a and the negative electrode current collector 2a or welding the electrode lead 20 to the positive electrode current collector 1a and the negative electrode current collector 2a (that is, from the viewpoint of performing the current collection or the welding in a wide space), it may be preferable to extend the positive electrode current collector 1a and the negative electrode current collector 2a long in a direction orthogonal to the stacking direction (FIG. 14 (a)). In this case, when the positive electrode current collector 1a and the negative electrode current collector 2a are collected and the electrode lead 20 is welded to these current collectors, as illustrated in FIG. 14(b), the electrode assembly 10 becomes long in a direction orthogonal to the stacking direction.

In order to relatively downsize the electrode assembly 10, for example, in the present embodiment, the positive electrode current collector 1a and the negative electrode current collector 2a may be bent along a facing direction in which the positive electrode 1 and the negative electrode 2 face each other (FIG. 15(a)). In other words, it may be bent along the outer peripheral edge of the electrode-constituting layer 5. According to such a configuration, it is possible to provide the electrode assembly 10 relatively downsized with respect to the direction orthogonal to the stacking direction, and it is possible to improve the energy density or the battery capacity per unit volume of the secondary battery.

In place of the embodiment illustrated in FIG. 15(a), as illustrated in FIG. 15(b), the positive electrode current collector 1a and the negative electrode current collector 2a may be wound along a direction perpendicular to a facing direction in which the positive electrode 1 and the negative electrode 2 face each other. Here, the term “wound” as used in the present specification means that the electrode lead 20 is wound while being twisted around the axis. Even with such a configuration, the electrode assembly 10 can be downsized, and the energy density per unit volume or the battery capacity of the secondary battery can be improved as described above.

### Third Embodiment of Secondary Battery

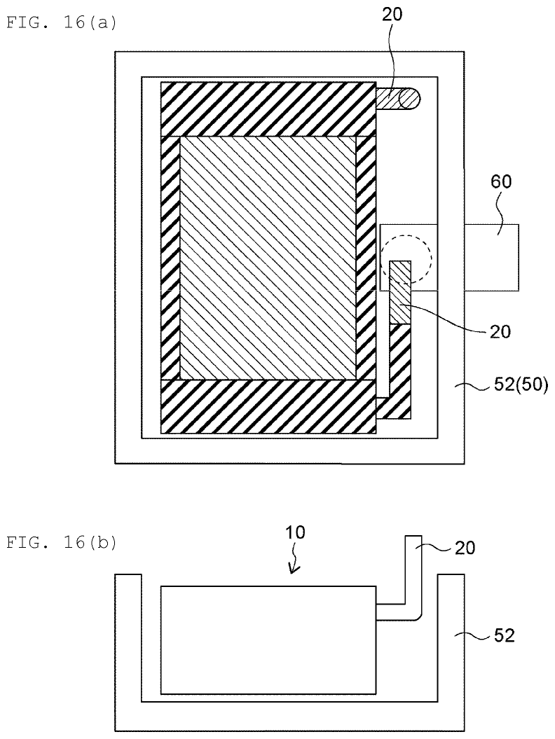

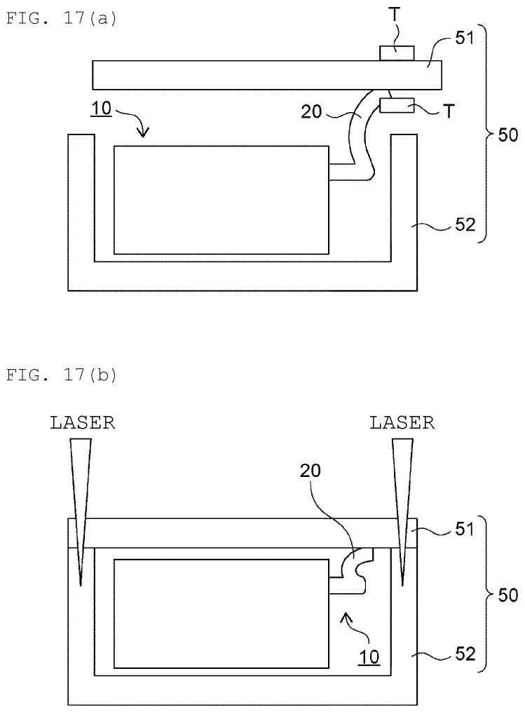

A secondary battery according to a third embodiment of the present invention will be described with reference to FIGS. 16(a) through 17(b). In the secondary battery according to the first embodiment, the configuration in which the other electrode lead 20 is electrically connected to the cup-shaped member 52 has been described, but in the present embodiment, the other electrode lead 20 may be electrically connected to the lid-shaped member 51.

That is, the other electrode lead 20 may be bent in the direction in which the cup-shaped member 52 is opened (refer to FIGS. 16(a) and 16(b)), and the other electrode lead 20 and the lid-shaped member 51 may be electrically connected using a resistance heating device T in a state in which the electrode lead 20 is in contact with the lid-shaped member 51 (FIG. 17 (a)). Then, the secondary battery 100 may be manufactured by laser welding the lid-shaped member 51 and the cup-shaped member 52. The electrical connection between the electrode lead 20 and the lid-shaped member 51 is not limited to the resistance heating device T, and other bonding methods may be adopted.

According to such an embodiment, although when an electrode rod or a laser beam does not reach a bottom surface of the cup-shaped member 52 when the electrode lead 20 is electrically connected to the cup-shaped member 52, the electrode lead 20 and the lid-shaped member 51 are electrically connected, and the cup-shaped member 52 is hermetically sealed and electrically connected by the lid-shaped member 51, and thereby the electrical connection from the electrode lead 20 to the cup-shaped member 52 is enabled.

### EXAMPLES

Examples related to the present invention will be described. Solid batteries of Examples 1 to 10 and Comparative Examples 1 to 5 below were created. That is, in Examples 1 to 10, the electrode lead is bendable in all directions, while in Comparative Examples 1 to 5, a belt-shaped tab as described in the prior art is used.

### Example 1

A secondary battery in which a circular electrode lead having a diameter of 0.5 mm (sectional area: 0.196 mm²) is electrically connected to a terminal.

### Example 2

A secondary battery in which a circular electrode lead having a diameter of 0.6 mm (sectional area: 0.283 mm²) is electrically connected to a terminal.

### Example 3

A secondary battery in which a circular electrode lead having a diameter of 0.8 mm (sectional area: 0.503 mm²) is electrically connected to a terminal.

### Example 4

A secondary battery in which a circular electrode lead having a diameter of 1.0 mm (sectional area: 0.785 mm²) is electrically connected to a terminal.

### Example 5

A secondary battery in which a circular electrode lead having a diameter of 1.5 mm (sectional area: 1.767 mm²) is electrically connected to a terminal.

### Example 6

A secondary battery in which an elliptical electrode lead having a major axis diameter of 0.526 mm and a minor axis diameter of 0.476 mm (sectional area: 0.196 mm²) is electrically connected to a terminal.

### Example 7

A secondary battery in which an elliptical electrode lead having a major axis diameter of 0.630 mm and a minor axis diameter of 0.570 mm (sectional area: 0.282 mm²) is electrically connected to a terminal.

### Example 8

A secondary battery in which an elliptical electrode lead having a major axis diameter of 0.840 mm and a minor axis diameter of 0.760 mm (sectional area: 0.501 mm²) is electrically connected to a terminal.

### Example 9

A secondary battery in which an elliptical electrode lead having a major axis diameter of 1.05 mm and a minor axis diameter of 0.950 mm (sectional area: 0.783 mm²) is electrically connected to a terminal.

### Example 10

A secondary battery in which an elliptical electrode lead having a major axis diameter of 1.575 mm and a minor axis diameter of 1.425 mm (sectional area: 1.763 mm²) is electrically connected to a terminal.

### Comparative Example 1

A secondary battery in which a belt-shaped tab having a width of 2 mm and a thickness of 0.1 mm (sectional area: 0.2 mm²) is electrically connected to an external terminal.

### Comparative Example 2

A secondary battery in which a belt-shaped tab having a width of 3 mm and a thickness of 0.1 mm (sectional area: 0.3 mm²) is electrically connected to an external terminal.

### Comparative Example 3

A secondary battery in which a belt-shaped tab having a width of 5 mm and a thickness of 0.1 mm (sectional area: 0.5 mm²) is electrically connected to an external terminal.

### Comparative Example 4

A secondary battery in which a belt-shaped tab having a width of 10 mm and a thickness of 0.1 mm (sectional area: 1.0 mm²) is electrically connected to an external terminal.

### Comparative Example 5

A secondary battery in which a belt-shaped tab having a width of 15 mm and a thickness of 0.1 mm (sectional area: 1.5 mm²) is electrically connected to an external terminal.

Tables 1 to 3 show calculated values of the second moment of area in Examples 1 to 10 and Comparative Examples 1 to 5. The second moment of area I is calculated by the following equation.

I=(π×d⁴)/64 (second moment of area when sectional shape is circle with diameter d)

I=(π×a×b³)/64 (second moment of area in minor axis direction when sectional shape is ellipse with major axis diameter a and minor axis diameter b)

I=(a×b³)/12 (second moment of area in direction b when sectional shape is a×b rectangle)

TABLE 1

| | Sectional | Second moment | Ratio of second |
|---|---|---|---|
| | area (mm²) | of area (mm⁴) | moment of area |
| Example 1 | 0.196 | 0.00307 | 1 |
| Example 2 | 0.283 | 0.00636 | 1 |
| Example 3 | 0.503 | 0.02011 | 1 |
| Example 4 | 0.785 | 0.04909 | 1 |
| Example 5 | 1.767 | 0.24850 | 1 |

TABLE 2

| | | | | Ratio of |
|---|---|---|---|---|
| | | Second moment | Second moment | second |
| | Sectional | of area Ix (mm⁴) | of area Iy (mm⁴) | moment |
| | area | (b = Minor axis | (b = Major axis | of area |
| | (mm²) | diameter) | diameter) | (Iy/Ix) |
| Example 6 | 0.196 | 0.00276 | 0.00337 | 1.22 |
| Example 7 | 0.282 | 0.00573 | 0.00700 | 1.22 |
| Example 8 | 0.501 | 0.01810 | 0.02211 | 1.22 |
| Example 9 | 0.783 | 0.04419 | 0.05398 | 1.22 |
| Example 10 | 1.763 | 0.22371 | 0.27329 | 1.22 |

TABLE 3

| | | | | Ratio of |
|---|---|---|---|---|
| | | | | second |
| | Sectional | Second moment | Second moment | moment |
| | area | of area Ix (mm⁴) | of area Iy (mm⁴) | of area |
| | (mm²) | (b = Thickness) | (b = Width) | (Iy/Ix) |
| Comparative | 0.2 | 0.00017 | 0.06667 | 392 |
| Example 1 | | | | |
| Comparative | 0.3 | 0.00025 | 0.22500 | 900 |
| Example 2 | | | | |
| Comparative | 0.5 | 0.00042 | 1.04167 | 2480 |
| Example 3 | | | | |
| Comparative | 1.0 | 0.00083 | 8.33333 | 10040 |
| Example 4 | | | | |
| Comparative | 1.5 | 0.00125 | 28.12500 | 22500 |
| Example 5 | | | | |

In the values of the second moment of area shown in Tables 1 to 3, when the value of the second moment of area is large, it means that bending is difficult. According to the above results, it can be seen that in Comparative Examples 1 to 5, the value of the second moment of area in the thickness direction is low and bending is easy, but the value of the second moment of area in the width direction is very high and bending is difficult. That is, since the secondary battery of Comparative Examples 1 to 5 has a high second moment of area in the width direction of the belt-shaped tab and is hardly bent, when the battery element moves in the width direction of the belt-shaped tab, stress is easily transmitted to the bonding portion of the tab, and there is a possibility that the bonding portion is damaged.

On the other hand, since Examples 1 to 5 are electrode leads having a circular cross section, the value of the second moment of area shows the same value in all directions (the ratio of the second moment of area is 1). That is, there is no restriction in the bending direction as compared with the belt-shaped tab described in the comparative examples. Therefore, although when an external impact or the like is applied, the electrode lead is bent in a free direction without being restricted, so that stress is less likely to be transmitted to the bonding portion, and the breakage occurrence rate can be reduced as compared with the belt-shaped tab. Furthermore, when the electrode assembly is housed in the exterior body, since the electrode lead can be freely bent, the housing work can be facilitated, and the degree of freedom of production facility design is increased.

Examples 6 to 10 are electrode leads having an elliptical cross section obtained by changing the diameter of Examples 1 to 5 by ±5% in the major axis direction and the minor axis direction. The value of the second moment of area of Examples 6 to 10 shows a value that does not significantly change depending on the bending direction as compared with Comparative Examples 1 to 5. Specifically, in Examples 6 to 10, a ratio of the second moment of area (second moment of area Iy/second moment of area Ix) is within 1.22 (within 22%), which is a preferable range as compared with Comparative Examples 1 to 5. With such a ratio of the second moment of area, it is possible to achieve an effect similar to that of an electrode lead having a circular cross section. Even when the ratio of the second moment of area is 25% or less, the same effect as described above is obtained.

Furthermore, the electrical resistance of the electrode lead tends to decrease as the sectional area increases, but for example, the sectional area (approximately 0.282 mm²) of the electrode lead of Example 2 or 7 is larger than the sectional area (0.2 mm²) of the belt-shaped tab of Comparative Example 1. Here, the electrode lead of Example 2 has a circular shape with a diameter of 0.6 mm (sectional area: 0.283 mm²), the electrode lead of Example 7 has an elliptical shape with a major axis diameter of 0.630 mm and a minor axis diameter of 0.570 mm (sectional area: 0.282 mm²), and the electrode lead of Comparative Example 1 has a belt shape with a width of 2 mm and a thickness of 0.1 mm (sectional area: 0.2 mm²). Therefore, when the electrode lead of the example has the same sectional area, the electrode lead can be made smaller than the width dimension of the belt-shaped tab of the comparative example, and the battery size can be reduced and/or the battery capacity can be improved. When the diameter of the electrode lead of the example is made equal to the width dimension of the belt-shaped tab of the comparative example, the sectional area of the electrode lead of the example is larger than the sectional area of the belt-shaped tab of the comparative example, and the electrical resistance of the electrode lead is reduced, so that the charging and discharging speed of the battery can be improved.

It is to be noted that embodiments disclosed herein are considered by way of illustration in all respects, and not considered as a basis for restrictive interpretations. Accordingly, the technical scope of the present invention is not to be construed only by the embodiments mentioned above, but is defined based on the description of the claims. In addition, the technical scope of the present invention encompasses meanings equivalent to the claims and all modifications within the scope of the claims.

The secondary battery according to the present invention can be used in various fields in which battery use or electricity storage is assumed. By way of example only, the secondary battery according to the present invention can be also used in the fields of electricity, information, and communication in which mobile devices and the like are used (for example, electric and electronic device fields or mobile device fields including mobile phones, smartphones, notebook computers and digital cameras, activity meters, arm computers, electronic paper, wearable devices, or small electronic machines such as RFID tags, card type electronic money, and smartwatches), home and small industrial applications (for example, the fields of electric tools, golf carts, and home, nursing, and industrial robots), large industrial applications (for example, the fields of forklift, elevator, and harbor crane), transportation system fields (for example, the fields of hybrid vehicles, electric vehicles, buses, trains, power-assisted bicycles, electric two-wheeled vehicles), power system applications (for example, the fields of various types of power generation, road conditioners, smart grids, and household power storage systems), medical applications (medical device fields such as earphone hearing aids), pharmaceutical applications (fields such as dosage management systems), IoT fields, space and deep sea applications (for example, the fields of a space probe and a submersible), and the like.

### DESCRIPTION OF REFERENCE SYMBOLS

1: Positive electrode
1a: Positive electrode current collector
1b: Positive electrode material layer
2: Negative electrode
2a: Negative electrode current collector
2b: Negative electrode material layer
3: Separator
5: Electrode-constituting layer
10: Electrode assembly
20: Electrode lead
30: Insulating member
50: Exterior body
51: Lid-shaped member
51s: Insulating member
52: Cup-shaped member
60: Terminal
100: Secondary battery
J: Jig
T: Resistance heating device

1. A secondary battery comprising:
an electrode assembly including a positive electrode, a negative electrode, and a separator between the positive electrode and the negative electrode;
an exterior body that houses the electrode assembly;
a terminal electrically connected to the positive electrode or the negative electrode; and
an electrode lead electrically connected to the terminal and the positive electrode or the negative electrode, the electrode lead being bendable in all directions.

2. The secondary battery according to claim 1, wherein the electrode lead has a value of second moment of area within 25% in the all directions.

3. The secondary battery according to claim 1, wherein the electrode lead is a wire rod having a circular or elliptical sectional shape.

4. The secondary battery according to claim 1, wherein the electrode lead is bent along an outer peripheral edge of the electrode assembly.

5. The secondary battery according to claim 1, wherein the positive electrode, the negative electrode, and the separator are stacked in a stacking direction.

6. The secondary battery according to claim 1, wherein the positive electrode or the negative electrode has a rectangular shape.

7. The secondary battery according to claim 1, further comprising: a current collector that collects a plurality of the positive electrodes or a plurality of the negative electrodes.

8. The secondary battery according to claim 7, wherein a width of the current collector is equal to a width of an electrode active material layer of the positive electrode or the negative electrode.

9. The secondary battery according to claim 7, wherein the current collector is bent along a direction in which the positive electrode and the negative electrode face each other.

10. The secondary battery according to claim 7, wherein the current collector is wound along a direction perpendicular to a direction in which the positive electrode and the negative electrode face each other.

11. The secondary battery according to claim 1, wherein, when the electrode lead is electrically connected to the positive electrode, a material of the electrode lead on a side of the positive electrode is aluminum; and when the electrode lead is electrically connected to the negative electrode, a material of the electrode lead on a side of the negative electrode includes at least one selected from the group consisting of nickel, copper, nickel-plated copper, and stainless steel.

12. The secondary battery according to claim 1, wherein the electrode lead is a first electrode lead that is electrically connected to the positive electrode and the terminal, and the secondary battery further includes a second electrode lead that is electrically connected to the negative electrode and the exterior body.

13. The secondary battery according to claim 1, wherein the exterior body includes a lid-shaped member and a cup-shaped member, and
the cup-shaped member includes the terminal.

14. The secondary battery according to claim 13, wherein the electrode lead is electrically connected to the lid-shaped member.

15. The secondary battery according to claim 1, wherein the positive electrode and the negative electrode are capable of occluding and releasing lithium ions.

16. A method of manufacturing a secondary battery, the method comprising:
bonding an electrode lead bendable in all directions to a positive electrode or a negative electrode of an electrode assembly that includes the positive electrode, the negative electrode and a separator between the positive electrode and the negative electrode; and
bending the electrode lead toward the terminal.

17. The method of manufacturing a secondary battery according to claim 16, wherein the electrode lead is bent along an outer peripheral edge of the electrode assembly.

18. The method of manufacturing a secondary battery according to claim 16, further comprising housing the electrode assembly in an exterior body.

19. The method of manufacturing a secondary battery according to claim 16, wherein the electrode lead has a value of second moment of area within 25% in the all directions.

20. The method of manufacturing a secondary battery according to claim 18, wherein the electrode lead is a first electrode lead that is electrically connected to the positive electrode and the terminal, and the method further comprises electrically connecting a second electrode lead to the negative electrode and the exterior body.
